(19) United States
(12) Patent Application Publication
(10) Pub. No.: US 2026/0298821 A1
(43) Pub. Date: Oct. 1, 2026

(54) DTOF-BASED VISIBILITY MEASUREMENT METHOD, SENSOR, AND VEHICLE

(71) Applicant: AUTOX TECH PTE. LTD., SINGAPORE (SG)

(72) Inventors: Menglei Ji, Shenzhen (CN); Xuhui Tao, Shenzhen (CN); Zhongle Wu, Shenzhen (CN); Haiyang Zhang, Shenzhen (CN); Puxi Hu, Shenzhen (CN)

(73) Assignee: AUTOX TECH PTE. LTD., SINGAPORE (SG)

(21) Appl. No.: 19/091,926

(22) Filed: Mar. 27, 2025

(51) Int. Cl. G01N 21/47; G01N 21/53; G01S 7/484

(52) U.S. Cl. CPC G01N 21/4795; G01N 21/53; G01S 7/484; G01N 2021/4797

(57) ABSTRACT

A dTOF-based visibility measurement method provided, includes steps of: controlling an optical emitter to emit light pulses; receiving, by an optical receiver, backscattered light pulses after the emitted light pulses are scattered, and converting the backscattered light pulses into electrical signals; calculating time intervals of the electrical signals and converting the time intervals into timestamps; counting photons corresponding to the timestamps; acquiring a photon count at specific timestamps; and calculating current visibility based on the photon count at the specific timestamps and a predetermined visibility mapping relationship, the predetermined visibility mapping relationship being a correspondence between the photon count at the specific timestamps and the visibility, one visibility corresponding to one count value or a count range value.

### TECHNICAL FIELD

The disclosure relates sensing technology, particularly to a dTOF-based visibility measurement method, a sensor, and a vehicle.

### BACKGROUND

Visibility is an important meteorological observation element, which can be used in meteorological analysis, aviation, navigation, road traffic, and other industrial fields. Currently, visibility is commonly measured using the scattering principle of optical among optical principles, such as with scattered visibility meters. Scattered visibility meters are classified into forward scattering and backward scattering based on the direction of measurement. Backward scattering visibility meters are applied in some mobile scenarios and scenarios with space constraints, such as ships and drones, due to their smaller dimensions and larger sampling area. However, the echo signal of backward scattering visibility meters is affected by atmospheric scattering and absorption, resulting in a weak echo signal, a limited measurement range for visibility, and poor accuracy.

### SUMMARY

In view of this, it is necessary to provide a dTOF-based visibility measurement method, sensor, and vehicle to improve the accuracy of visibility measurement.

In a first aspect, a dTOF-based visibility measurement method is provided, the dTOF-based visibility measurement method contained steps of: controlling an optical emitter to emit light pulses; receiving, by an optical receiver, backscattered light pulses after the emitted light pulses are scattered, and converting the backscattered light pulses into electrical signals; calculating time intervals of the electrical signals and converting the time intervals into timestamps; counting photons corresponding to the timestamps; acquiring a photon count at specific timestamps, the specific timestamps consisting of a set of a plurality of timestamps that are continuous in time, the photon count at the specific timestamps configured to present fluctuations in the backscattered light pulses resulting from particulate matter in the air, the backscattered light pulses from particulate matter in the air being the backscattered light pulses formed by the emitted light pulses being scattered by particulate matter in the air; and calculating current visibility based on the photon count at the specific timestamps and a predetermined visibility mapping relationship, the predetermined visibility mapping relationship being a correspondence between the photon count at the specific timestamps and the visibility, one visibility corresponding to one count value or a count range value.

In a second aspect, a dTOF-based visibility sensor is provided. The dTOF-based visibility sensor includes an optical transceiver device, a time-to-digital conversion device, a counting device, and a signal processing device. The optical transceiver device includes an optical emitter and an optical receiver, the optical emitter emits light pulses; the optical receiver receives backscattered light pulses after the emitted light pulses are scattered, and converts the backscattered light pulses into electrical signals. The time-to-digital conversion device is configured to calculate time intervals of the electrical signals and converts the time intervals into timestamps. The counting device is configured to count the photons corresponding to the timestamps based on the timestamps. The signal processing device includes a control unit, a statistics unit, and a calculation unit. The control unit is configured to control the operation of the optical transceiver device, the time-to-digital conversion device, and the counting device. The statistics unit is configured to acquire a photon count at a specific timestamps. The calculation unit is configured to calculate current visibility based on the photon count at the specific timestamps and a predetermined visibility mapping relationship, the predetermined visibility mapping relationship the predetermined visibility mapping relationship is a correspondence between the photon count at the specific timestamps and the visibility, one visibility corresponding to one count value or a count range value; the specific timestamps consists of a set of a plurality of timestamps that are continuous in time, the photon count at the specific timestamps is configured to present fluctuations in the backscattered light pulses resulting from particulate matter in the air, the backscattered light pulses from particulate matter in the air are the backscattered light pulses formed by the emitted light pulses being scattered by particulate matter in the air.

In a fourth aspect, a vehicle, said vehicle comprising a body, the aforementioned dTOF-based visibility sensor disposed on said body, and a main control device; the dTOF-based visibility sensor is used for calculating the current visibility; the main control device is used for executing corresponding operations based on said current visibility.

The aforementioned dTOF-based visibility measurement method accurately obtains the amount of data related to visibility measurement through counting photons at specific timestamps. Since the photon count at specific timestamps is not an analog signal, the accuracy of visibility measurement is further improved.

### BRIEF DESCRIPTION OF THE DRAWINGS

To more clearly illustrate the technical solutions in the embodiments of the present application or in the prior art, the drawings required for describing the embodiments or the prior art will be briefly introduced below. It is evident that the drawings described below are merely some embodiments of the present application. For ordinary technicians in the field, other drawings can be obtained based on the structures shown in these drawings without inventive effort.

FIG. 1 is a schematic diagram of the structure of a dTOF-based visibility sensor in accordance with an embodiment.

FIG. 2 is a flowchart of the dTOF-based visibility measurement method in accordance with an embodiment.

FIG. 3 is a schematic diagram of a sensing scenario of the dTOF-based visibility sensor provided by an embodiment of the present application.

FIG. 4 is a schematic diagram of fitting sensing data of the dTOF-based visibility sensor in accordance with an embodiment.

FIG. 5 is a schematic diagram of the sensing effect of the dTOF-based visibility sensor in accordance with an embodiment.

FIG. 6 is a schematic diagram of the functional modules of a signal processing device of the dTOF-based visibility sensor in accordance with an embodiment.

FIG. 7 is a schematic diagram of the structure of a signal processing device of the dTOF-based visibility sensor in accordance with an embodiment.

FIG. 8 is a schematic diagram of a vehicle applying the dTOF-based visibility sensor in accordance with an embodiment.

The achievement of the objectives, functional features, and advantages of the present application will be further explained with reference to the embodiments and drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third," “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms "include" and "have" and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

Particulate matter in the air, including fog, water droplets, small sand grains, etc., is a key factor influencing visibility. Visibility detection methods using backscatter, are susceptible to atmospheric scattering and absorption.,This susceptibility leads to weak echo signals, which pose challenges to accurate measurement.. dTOF is capable of receiving light pulses scattered back from targets at varying distances. These receive light pulses also give rise to different time intervals. Research has shown that when dTOF is employed for measurement, particulate matter in the air scatters the light pulses. Notably, even at close distances, the scattering of light pulses by the airborne particulate matter can be detected. The scattering of light pulses can reflect the concentration of particulate matter in the air, which in turn indicates the visibility, It is acknowledged that particulate matter in the air is usually uniformly distributed. When visibility is high, the density of particulate matter in the air is relatively low, and that fewer photons are scattered back by the particulate matter in the air. Conversely, more photons are scattered back, when the visibility is low, more photons are scattered back by the particulate matter in the air. Therefore, visibility can be measured using the first received backscattered light pulses. This is because the first received backscattered light pulses is less affected by atmospheric scattering and absorption. At the same time, since dTOF uses digital signals instead of analog signals during the measurement process, it further reduces the impact of atmospheric scattering and absorption, significantly improving the accuracy.

In optical of this, the present application presents a visibility measurement method based on dTOF, utilizing dTOF for visibility measurement. The specific implementation plan of the visibility measurement method based on dTOF will be described in detail below.

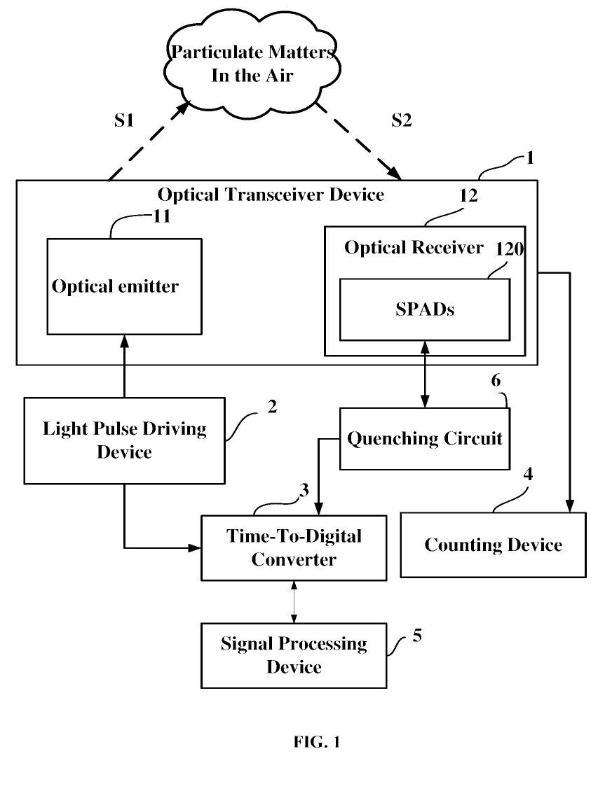

Referring to FIG. 1, which is a schematic diagram of the structure of a dTOF-based visibility sensor provided in an embodiment of the present application. The dTOF-based visibility sensor 99 includes an optical transceiver device 1, a light pulse driving device 2, a time-to-digital converter 3, a counting device 4, and a signal processing device 5. Among these components, the transceiver device 1, the light pulse driving device 2, the time-to-digital converter 3, and the counting device 4 operate under the control of the signal processing device 5.

The optical transceiver device 1 includes an optical emitter 11, and an optical receiver 12. The optical emitter 11 emits emitted light pulses S1. The optical receiver 12 receives/detects a backscattered light pulses S2 which is genenrates after the emitted light pulses S1 are scattered and converts these backscattered light pulses S2 intoelectrical signals S3. Specifically, in this embodiment, the optical emitter 11 is a VCSEL laser emitter. The optical receiver 12 includes multiple Single-Photon Avalanche Diodes (SPADs) 120, which are used to sense the backscattered light pulses S2 that is scattered towards the optical receiver 12.

It is well-known that the emitted light pulses contains photons, and accordingly the backscattered light pulses S2 also contains photons. The optical receiver 12 is capable of detecting these photons. When the SPADs 120 senses a photon, it experiences an avalanche effect and switches from an active state to an inactive state.The optical receiver 12 can detect these photons. The SPADs 120 undergoes avalanche and transitions from an active state to an inactive state upon sensing a photon.

Furthermore, the dTOF-based visibility sensor 99 further includes a quenching circuit 6 that switches the SPADs 120 from an inactive state to an active state. Specifically, after the SPADs 120 have undergone an avalanche process, the quenching circuit 6 restores the SPADs 120 from an inactive state to an active state, preparing them for the next photon sensing. That is to say, the number of times the SPADs 120 experience an avalanche is equal to the number of photons sensed. The optical receiver 12 generates corresponding electrical signals based on the states of the SPADs 120,thus achieving the conversion from optical signals to electrical signals..

The light pulse driving device 2 is configured to control the optical emitter 11 to output the emitted light pulses S1 and to control the pulse width of the emitted light pulses S1. In this embodiment, the pulse width of the emitted light pulses S1 is 1 nanosecond (ns), with a period of 5 ns.

The time-to-digital converter 3 is configured to calculate the time intervals T of the electrical signal S3 and convert the time intervals T into timestamps. Specifically, to ensure the accuracy of the time interval T calculated by the time-to-digital converter 3, the signal processing device 5 controls the time-to-digital converter 3 to send a driving signal STAR to the light pulse driving device 2 and starts timing, That is, an emission time T0 of the emitted light pulses S1 is obtained, and the timing begins. The time-to-digital converter 3 is also electrically connected to the quenching circuit 6. When the optical receiver 12 senses a photon, that is, when the SPADs 120 experiences an avalanche, a stop signal is sent through the quenching circuit 6 to the time-to-digital converter 3 to control the time-to-digital converter 3 to stop the current timing, the quenching device 6 sends a stop signal to the time-to-digital converter device 3 to control the time-to-digital converter device 3 to stop the current timing. In this way, a reception time T1 of the backscattered light S2 can be obtained. Thus, the time interval T can be calculated based on the emission time T0 and the reception time T1.

The counting device 4 is configured to count photons based on timestamps corresponding to these photons. Specifically, a histogram is utilized to count photons based on these timestamps. It is understandable that since the backscattered light pulses are scattered by particulate matter in the air at different distances, there are photon counts at successive timestamps.

The signal processing device 5 is configured to obtain the photon count at specific timestamps and calculate the current visibility based on the photon count at these specific timestamps and a predetermined visibility mapping relationship. Wherein, the predetermined visibility mapping relationship is a relationship between the photon count at the specific timestamps and the visibility, where one visibility corresponds to a count value or a count range value. The specific timestamps consist of a group of multiple timestamps that are continuous in time, and the photon count at these specific timestamps reflects the changes in the backscattered light pulses from the particulate matter in the air. The backscattered light pulses from particulate matter in the air is the backscattered light pulses S2. The specific timestamps are multiple timestamps within a predetermined time, starting from the earliest timestamps.

Further, among all timestamps, the timestamps of a first peak and the timestamps prior to the timestamps of the first peak are regarded as the specific timestamps, with the timestamps of the first peak being the timestamps where the count peak first appears among all timestamps. The photon counts at the specific timestamps and the setting of the predetermined visibility mapping relationship are described in detail below.

Referring to FIG. 6, a schematic diagram of the functional modules of the signal processing device for a dTOF-based visibility sensor is illustrated.

The signal processing device 5 includes a control unit 51, a statistics unit 52, and a computation unit 53. The control unit 51 is capable of controlling the operation of the optical transceiver device, the time-to-digital converter, and the counting device. The statistics unit 52 is configured to obtain the photon counts at specific timestamps. The computation unit 53 calculates the current visibility based on the photon counts at specific timestamps and the predetermined visibility mapping relationship.

It is understandable that, in order to further save the power consumption of the counting device 3 and the storage space occupied by the counting of the counting device 3, the counting device 3 only needs to count photons at specific timestamps and abandon counting at non-specific timestamps.

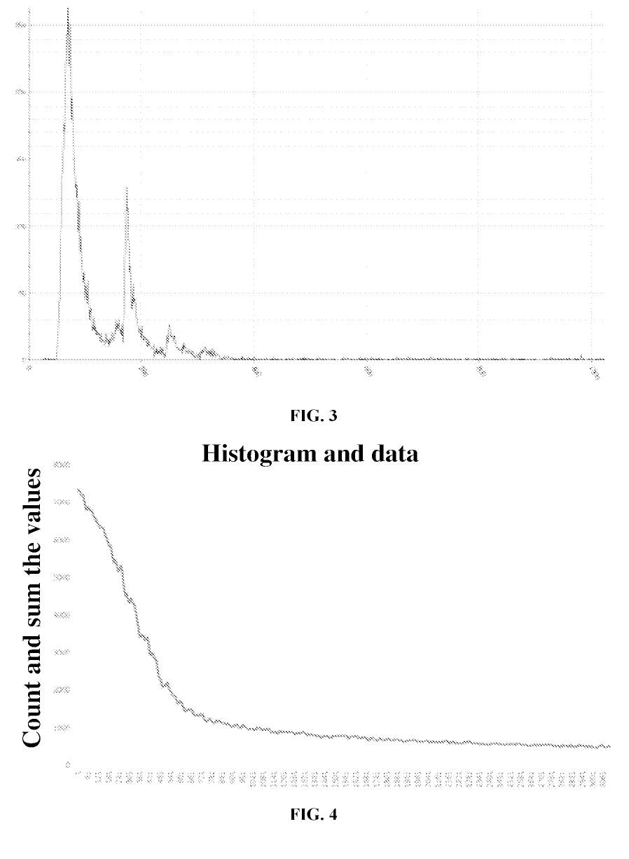

Referring to FIG. 3, a schematic diagram of the sensing scenario of the dTOF-based visibility sensor is illustrated.

The number of timestamps on the horizontal axis represents the number of bits of the TDC. The number of timestamps for an N-bit TDC is 2^N, and the time width of each timestamp is the time resolution of the TDC. The vertical axis “count” of the histogram represents the number of times photons are received at corresponding timestamps. It can be seen from FIG. 3 that, the first 150 timestamps correspond to variations in the intensity of scattered light pulses of particulate matter in the air. In this embodiment, the specific timestamps are set from the 1st timestamps to the 150th timestamps.

Further, since the first 150 timestamps correspond to variations in the intensity of scattered light pulses from particulate matter in the air, the present application fits the changes in visibility by statistically analyzing the changes in count values of the first 150 timestamps to determine the predetermined visibility mapping relationship.

Refer to FIG. 4, a schematic diagram of the fitting of sensing data of a dTOF-based visibility sensor is illustrated.

In this embodiment, FIG. 4 shows the changes in the sum of photon counts at the first 150 timestamps of the histogram when the visibility varies from 5 m to 150 m, where the sum is obtained by adding up the count values (count) of the first 150 timestamps of the histogram. Specifically, when the visibility is lower, the sum of photon counts at the first 150 timestamps of the histogram is larger; when the visibility is higher, the sum of photon counts at the first 150 timestamps of the histogram is smaller. Therefore, based on the predetermined visibility mapping relationship between the intensity changes of the sum signal and the changes in visibility, the sum value of the histogram can be fitted to the changes in visibility..

In the above embodiment, the dTOF-based visibility measurement method accurately obtains data volume related to visibility measurement through photon counts at the specific timestamps. Since the photon counts at the specific timestamps are not analog signals, the accuracy of visibility measurement is further improved.

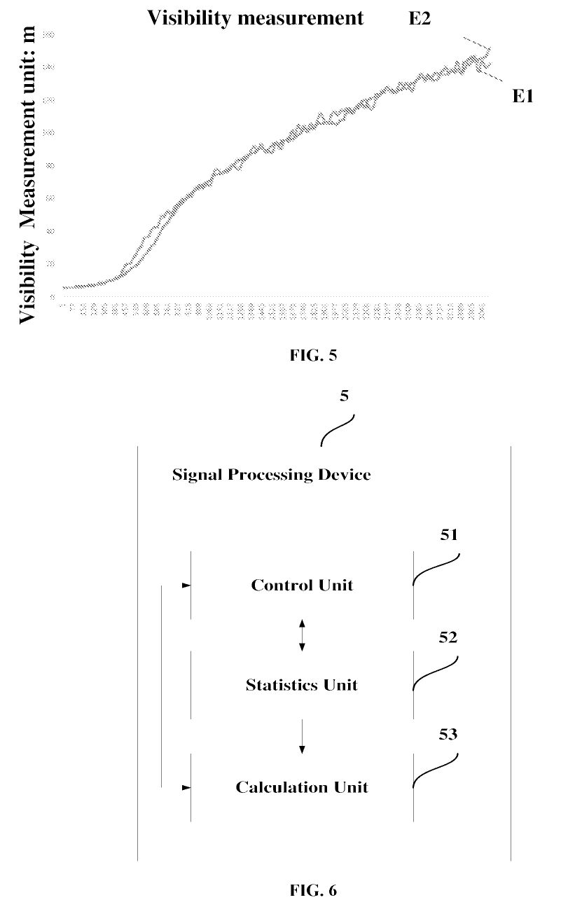

Referring to FIG. 5, a schematic diagram of the sensing effect of a dTOF-based visibility sensor is illustrated.

As shown in FIG. 5, a curve E1 represents a result curve of measuring visibility using the dTOF-based visibility sensor 99. A Curve E2 represents a result curve of measuring visibility using a standard visibility sensor. As can be seen from the figure, by placing the standard visibility measurement instrument and the dTOF-based visibility sensor in the same environment for testing, when visibility changes from 5m to 150m, the maximum error is ±10m. In other words, using the dTOF-based visibility sensor 99 to measure the visibility meets the precise visibility measurement standard.

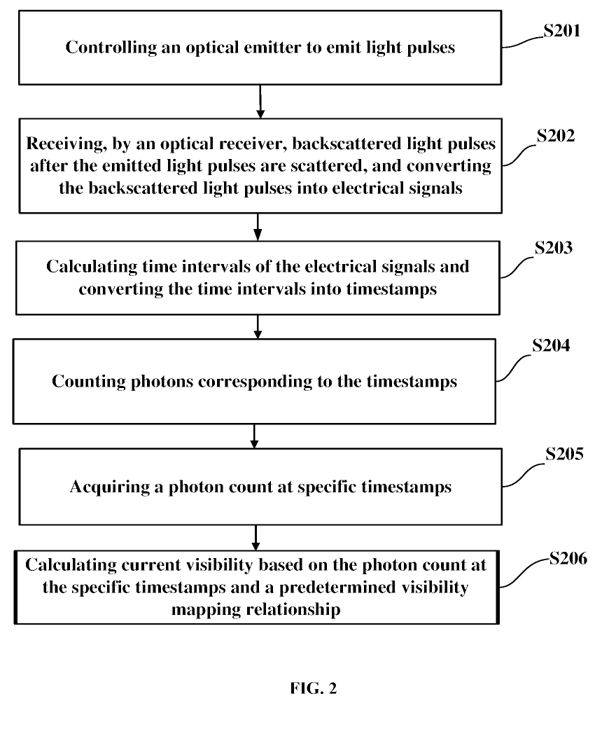

Referring to FIG. 2, a flowchart of a dTOF-based visibility measurement method is illustrated. The dTOF-based visibility measurement method includes steps S201-S206.

In Step S201: controlling the light emitter to emit an emitted light pulses.

In this embodiment, the optical emitter 11 emits an emitted light pulses S1 under the drive of the light pulse driving device 2. Among them, the pulse width of the emitted light pulses S1 is 1ns, and the frequency is 5ns.

In Step S202: receiving the backward scattered light pulses are received by an optical receiver, and converting the backward scattered light pulses into an electrical signal.

In this embodiment, multiple SPADs 120 are utilized to sense the backscattered light pulses S2 scattered towards the optical receiver 12. The backscattered light pulses S2 contain photons, which can be sensed by the optical receiver 12. When sensing a photon, each SPAD 120 experiences an avalanche transition from an active state to an inactive state and is then reset from the inactive state to the active state by the quenching circuit 6. Specifically, after the avalanche of the SPADs 120, the quenching device 6 returns the SPADs 120 from the inactive state to the active state, preparing them for the next photon sensing. That is to say, the number of times the SPADs 120 experience the avalanche is equal to the number of photons sensed.

In Step S203: calculating the time intervals of the electrical signals and convert these intervals into timestamps.

Specifically, to ensure the accuracy of time intervals T calculated by the time-to-digital converter 3, a signal processing device 5 controls the time-to-digital converter 3 to send a drive signal STAR to the light pulses drive device 2 and initiates timing, thus obtaining the emission time T0 of the emitted light pulses S1 and starting the timing process. The time-to-digital converter 3 is also electrically connected to the quenching circuit 6. When the optical receiver 12 senses a photon, i.e., when the SPAD 120 undergoes an avalanche, a stop signal is sent via the quenching circuit 6 to the time-to-digital converter 3 to terminate the current timing, thereby obtaining the reception time T1 of the backscattered optical S2. Thus, the time interval T can be determined based on the emission time T0 and the reception time T1.

In Step S204: counting photons corresponding to their respective timestamps, with each timestamps representing a time range.

Specifically, a histogram is configured to count photons based on their respective timestamps. It is understandable that due to the backscattering of the emitted light pulses by particulate matter in the air at different distances, different timestamps appear, meaning that there will be numerous timestamps. These timestamps are arranged in chronological order.

In Step S205: obtaining the photon count at specific timestamps, where a specific timestamps consists solely of a group of temporally consecutive timestamps. The photon count at the specific timestamps reflects changes in the backscattered light pulses from particulate matter in the air, which are formed by the emission light pulses scattered by particulate matter in the air.

In this embodiment, specific timestamps refer to the multiple timestamps within a predetermined time period, starting from the earliest timestamps. Further, among all timestamps, the timestamps of the first peak and those before it constitute specific timestamps. The timestamps of the first peak is the first occurrence of a peak count among all timestamps. The setting of specific timestamps can refer to the detailed description above and will not be repeated here.

In Step S206: calculating a current visibility based on the photon count at specific timestamps and a predetermined visibility mapping relationship. The predetermined visibility mapping relationship is the correspondence between the photon count at specific timestamps and visibility, where one visibility corresponds to a count value or a count range value

In this embodiment, the predetermined visibility mapping relationship is the relationship between the photon count at specific timestamps and visibility, where one visibility corresponds to a count value or a count range value. A specific timestamps consists solely of a group of temporally consecutive timestamps, and the photon count at the specific timestamps reflects changes in the backscattered light pulses from particulate matter in the air. These backscattered light pulses are formed by the emission light pulses being scattered by particulate matter in the air. The specific timestamps are multiple timestamps within a predetermined time period, starting from the earliest timestamps.

Furthermore, among all timestamps, the timestamps of the first peak and those before it constitute specific timestamps. The timestamps of the first peak is the first occurrence of a peak count among all timestamps. The setting of the predetermined visibility mapping relationship can refer to the detailed description above and will not be repeated here.

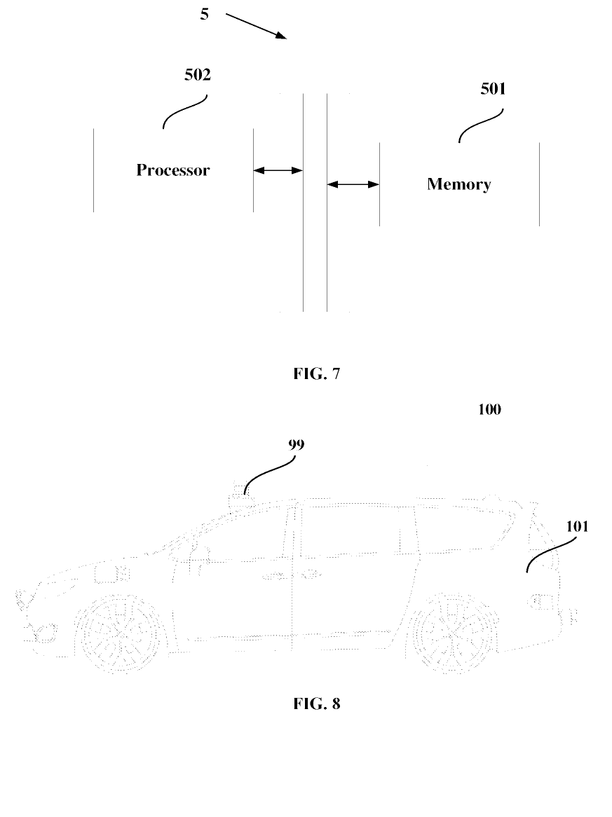

Referring to FIG. 7, a schematic diagram of the structure of a signal processing device for a dTOF-based visibility sensor is illustrated. The signal processing device 5 includes a memory 501 and a processor 502. The processor 502 is configured to execute computer program instructions stored in the memory 501 to implement the dTOF-based visibility measurement method.

The memory 501 includes at least one type of readable storage medium, which includes flash memory, a hard disk, a multimedia card, a card-type memory (such as SD or DX memory, etc.), magnetic memory, a magnetic disk, an optical disk, etc. In some embodiments, the memory 501 can be an internal storage unit of a computer device, such as a hard disk of a computer device. In other embodiments, the memory 501 can also be a storage device of an external computer device, such as a plug-in hard disk, a Smart Media Card (SMC), a Secure Digital (SD) card, a Flash Card, etc., configured on the computer device. Furthermore, the memory 501 can include both an internal storage unit and an external storage device of a computer device. The memory 501 can not only be used to store application software and various data installed on the computer device, such as the code for the dTOF-based visibility measurement method, but can also be used to temporarily store data that has been output or will be output.

FIG. 7 only shows the signal processing device 5 with some components. Those skilled in the art can understand that the structure shown in FIG. 7 does not constitute a limitation on the signal processing device 5, which can include fewer or more components than shown, or combine certain components, or have different component arrangements.

Referring to FIG. 8, which is a schematic diagram of a vehicle that applies a dTOF-based visibility sensor 99 is illustrated.

As shown in FIG. 8, the vehicle 100 includes a vehicle body 101, a dTOF-based visibility sensor 99 disposed on the vehicle body 101, and a main control device (not shown). The dTOF-based visibility sensor 99 is described above and will not be repeated here. The main control device is configured to perform corresponding operations based on the current visibility. For example, it adjusts the vehicle speed, headlights, brakes, etc., to appropriate states based on the visibility. In this embodiment, the vehicle can be a manually driven vehicle or an autonomous vehicle. In other feasible embodiments, the dTOF-based visibility sensor 99 can also be applied to devices affected by visibility, such as drones and ships.

In the above embodiments, the light pulses are emitted to receive reflected light pulses, which are converted into electrical signals. The time intervals of the electrical signals are calculated and converted into timestamps. Counts are performed based on the timestamps and corresponding photons. The current visibility is calculated based on this count and the predetermined visibility mapping relationship. Calculating visibility in the form of electrical signals allows for effective detection of subtle changes in visibility when the optical signals emitted by the visibility measurement device are limited.

Obviously, those skilled in the art can make various modifications and variations to the present application without departing from its spirit and scope. Thus, if these modifications and variations of the present application fall within the scope of the claims and their equivalents, the present application is also intended to include these modifications and variations.

The above-enumerated embodiments are merely preferred embodiments of the present application and cannot be used to limit the scope of the present application. Therefore, equivalent changes made in accordance with the claims of the present application still fall within the scope covered by the present application.

1. A dTOF-based visibility measurement method, comprising:
controlling an optical emitter to emit light pulses;
receiving, by an optical receiver, backscattered light pulses after the emitted light pulses are scattered, and converting the backscattered light pulses into electrical signals;
calculating time intervals of the electrical signals and converting the time intervals into timestamps;
counting photons corresponding to the timestamps;
acquiring a photon count at specific timestamps, the specific timestamps consisting of a set of a plurality of timestamps that are continuous in time, the photon count at the specific timestamps configured to present fluctuations in the backscattered light pulses resulting from particulate matter in the air, the backscattered light pulses from particulate matter in the air being the backscattered light pulses formed by the emitted light pulses being scattered by particulate matter in the air; and
calculating current visibility based on the photon count at the specific timestamps and a predetermined visibility mapping relationship, the predetermined visibility mapping relationship being a correspondence between the photon count at the specific timestamps and the visibility, one visibility corresponding to one count value or a count range value.

2. The dTOF-based visibility measurement method according to claim 1, wherein the plurality of timestamps are arranged in chronological order, the specific timestamps refers to the plurality of timestamps within a predetermined time, the predetermined time starts from the earliest timestamps.

3. The dTOF-based visibility measurement method according to claim 1, wherein among all timestamps, the timestamps of the first peak and timestamps before the timestamps of the first peak are defined as the specific timestamps, the timestamps of the first peak refers to the timestamps at which the photon count first reaches a peak among all the timestamps.

4. The dTOF-based visibility measurement method according to claim 3, wherein predetermined visibility mapping relationship is a relationship between the sum of all counts at the specific timestamps and visibility; the optical emitter is a VCSEL laser emitter, the optical receiver is a single-photon avalanche diode, and the particulate matter in the air is fog.

5. The dTOF-based visibility measurement method according to claim 1, wherein counting photons corresponding to the timestamps specifically comprises: only counting photons at the specific timestamps.

6. The dTOF-based visibility measurement method according to claim 1, wherein counting photons corresponding to the timestamps further comprises: using a histogram to count photons corresponding to the timestamps.

7. A dTOF-based visibility sensor, comprising:
an optical transceiver device, comprising an optical emitter and an optical receiver, the optical emitter emitting light pulses; the optical receiver receiving backscattered light pulses after the emitted light pulses are scattered, and converting the backscattered light pulses into electrical signals;
a time-to-digital conversion device, configured to calculate time intervals of the electrical signals and converting the time intervals into timestamps;
a counting device, configured to count the photons corresponding to the timestamps based on the timestamps; and
a signal processing device, comprising:
a control unit, configured to control the operation of the optical transceiver device, the time-to-digital conversion device, and the counting device;
a statistics unit, configured to acquire a photon count at a specific timestamps; and
a calculation unit, configured to calculate current visibility based on the photon count at the specific timestamps and a predetermined visibility mapping relationship, the predetermined visibility mapping relationship the predetermined visibility mapping relationship being a correspondence between the photon count at the specific timestamps and the visibility, one visibility corresponding to one count value or a count range value; the specific timestamps consisting of a set of a plurality of timestamps that are continuous in time, the photon count at the specific timestamps configured to present fluctuations in the backscattered light pulses resulting from particulate matter in the air, the backscattered light pulses from particulate matter in the air being the backscattered light pulses formed by the emitted light pulses being scattered by particulate matter in the air.

8. The dTOF-based visibility sensor according to claim 7, wherein the plurality of timestamps are arranged in chronological order, the specific timestamps refers to the plurality of timestamps within a predetermined time, the predetermined time starts from the earliest timestamps.

9. The dTOF-based visibility sensor according to claim 7, wherein among all timestamps, the timestamps of the first peak and timestamps before the timestamps of the first peak are defined as the specific timestamps, the timestamps of the first peak refers to the timestamps at which the photon count first reaches a peak among all the timestamps.

10. The dTOF-based visibility sensor according to claim 9, wherein predetermined visibility mapping relationship is a relationship between the sum of all counts at the specific timestamps and visibility.

11. The dTOF-based visibility sensor according to claim 7, wherein the optical emitter is a VCSEL laser emitter, and the optical receiver is a single-photon avalanche diode.

12. The dTOF-based visibility sensor according to claim 7, wherein the particulate matter in the air is fog.

13. The dTOF-based visibility sensor according to claim 7, wherein counting photons corresponding to the timestamps specifically comprises: only counting photons at the specific timestamps.

14. The dTOF-based visibility sensor according to claim 7, wherein counting photons corresponding to the timestamps further comprises: using a histogram to count photons corresponding to the timestamps.

15. A vehicle, wherein the vehicle comprises:
a vehicle body;
a dTOF-based visibility sensor, mouted on thevehicle body, the dTOF-based visibility sensor comprising:
an optical transceiver device, comprising an optical emitter, and an optical receiver;
a time-to-digital conversion device;
a counting device; and
a signal processing device, comprising:
a memory for storing computer-executable programs; and
a processor for executing the computer-executable programs to implement a dTOF-based visibility measurement method, the dTOF-based visibility measurement method, comprising:
controlling an optical emitter to emit light pulses;
receiving, by an optical receiver, backscattered light pulses after the emitted light pulses are scattered, and converting the backscattered light pulses into electrical signals;
calculating time intervals of the electrical signals and converting the time intervals into timestamps;
counting photons corresponding to the timestamps;
acquiring a photon count at specific timestamps, the specific timestamps consisting of a set of a plurality of timestamps that are continuous in time, the photon count at the specific timestamps configured to present fluctuations in the backscattered light pulses resulting from particulate matter in the air, the backscattered light pulses from particulate matter in the air being the backscattered light pulses formed by the emitted light pulses being scattered by particulate matter in the air; and
calculating current visibility based on the photon count at the specific timestamps and a predetermined visibility mapping relationship, the predetermined visibility mapping relationship being a correspondence between the photon count at the specific timestamps and the visibility, one visibility corresponding to one count value or a count range value.

16. The vehicle according to claim 15, wherein the plurality of timestamps are arranged in chronological order, the specific timestamps refers to the plurality of timestamps within a predetermined time, the predetermined time starts from the earliest timestamps.

17. The vehicle according to claim 15, wherein among all timestamps, the timestamps of the first peak and timestamps before the timestamps of the first peak are defined as the specific timestamps, the timestamps of the first peak refers to the timestamps at which the photon count first reaches a peak among all the timestamps.

18. The vehicle according to claim 17, wherein predetermined visibility mapping relationship is a relationship between the sum of all counts at the specific timestamps and visibility; the optical emitter is a VCSEL laser emitter, the optical receiver is a single-photon avalanche diode, and the particulate matter in the air is fog.

19. The vehicle according to claim 15, wherein counting photons corresponding to the timestamps specifically comprises: only counting photons at the specific timestamps.

20. The vehicle according to claim 15, wherein counting photons corresponding to the timestamps further comprises: using a histogram to count photons corresponding to the timestamps.
